(19) United States
(12) Patent Application Publication
(10) Pub. No.: US 2019/0118229 A1
(43) Pub. Date: Apr. 25, 2019

(54) Blade Lubricating and Cleansing System

(71) Applicants: Daniel S. Mason, Minneapolis, MN (US); Hunter Mason, Minneapolis, MN (US); Michelle Lipkie, Minneapolis, MN (US)

(72) Inventors: Daniel S. Mason, Minneapolis, MN (US); Hunter Mason, Minneapolis, MN (US); Michelle Lipkie, Minneapolis, MN (US)

(21) Appl. No.: 16/159,249

(22) Filed: Oct. 12, 2018

Related U.S. Application Data
(60) Provisional application No. 62/574,753, filed on Oct. 20, 2017.

(51) Int. Cl. B08B 7/00; B26B 21/40

(52) U.S. Cl. CPC B08B 7/0014; B26B 21/40

(57) ABSTRACT

A razor blade lubricating and cleansing system for the maintenance and cleansing of razor blades used for shaving. The razor blade lubricating and cleansing system includes a wax core held inside a tubular housing designed to extrude debris from gaps between a plurality of razor blades upon application, such that waste material is removed, and a coating of wax is formed along the edge and over the surface of each razor blade. The tubular housing includes a removable cap disposed on a top end, and a rotatable base on a bottom end designed to raise the wax core upwards when rotated in a clockwise direction, such that the raised portion is exposed and accessible. The rotatable base is also designed to lower the wax core downwards when rotated in an anticlockwise direction, such that the lowered portion is securely stowed within the tubular housing.

### CROSS REFERENCE TO RELATED APPLICATION

This application claims the benefit of U.S. Provisional Application No. 62/574,753 filed on Oct. 20, 2017. The above identified patent application is herein incorporated by reference in its entirety to provide continuity of disclosure.

### BACKGROUND OF THE INVENTION

The present invention relates to the maintenance and cleansing of razor blades used for shaving. More specifically, the present invention provides a composition and delivery system for lubricating and cleaning razor blades.

Many individuals shave themselves utilizing disposable razors for the convenience and low costs involved. However, when the blades of a disposable razor begin to dull or rust, the razor has to be discarded. This is not only costly, but also bad for the environment as the plastic builds up in landfills. While some individuals continue to use dull or rusty razors, doing so can cause injuries such as cuts to the skin. In general, disposable razors include blades that are unable to be sharpened, so consumers are forced to discard and replace the disposable razor after a limited number of uses. In order to address these concerns, the present invention provides a composition and delivery system for applying a lubricating coating to a razor blade in order to clean, maintain sharpness, and extend the lifespan of disposable razors.

Devices have been disclosed in the known art that relate to the maintenance and cleansing of razor blades. These include devices that have been patented and published in patent application publications. These devices generally relate to applicators that include a pressurized lubricant that dispense a wax like substance onto the edge of a razor blade. However, these devices do not utilize a wax core configured to extrude debris from between a plurality of razor blades such that a coating of wax is formed on the edge of each blade.

In light of the devices disclosed in the known art, it is submitted that the present invention substantially diverges in design elements from the known art and consequently it is clear that there is a need in the art for an improvement to existing razor blade maintenance and cleansing devices. In this regard the instant invention substantially fulfills these needs.

### SUMMARY OF THE INVENTION

In view of the foregoing disadvantages inherent in the known types of razor blade maintenance and cleansing devices now present in the known art, the present invention provides a new system for maintaining and cleaning razor blades wherein the same can be utilized for providing convenience for the user when attempting to extend the shelf-life of their razor blades.

It is therefore an object of the present invention to provide a new and improved razor blade maintenance and cleansing device that has all of the advantages of the known art and none of the disadvantages.

Another object of the present invention is to provide a wax core disposed within a tubular housing configured to extrude debris from between a plurality of razor blades upon application, such that waste material is removed, and a coating of wax is formed along the edge and over the surface of each razor blade.

Yet another object of the present invention is to provide a tubular housing having a removable cap disposed on a top end, and a rotatable base disposed on a bottom end configured to raise the wax core upwards when rotated in a clockwise direction, such that the raised portion is exposed and accessible.

A further object of the present invention is to provide a rotatable base being further configured to lower the wax core downwards when rotated in an anticlockwise direction, such that the lowered portion is securely stowed within the tubular housing.

Another object of the present invention is to provide a composition of the wax core comprises: aloe vera; cocoa butter; caranauba wax; glycerin; coconut oil.

Yet another object of the present invention is to provide a composition of the wax core comprises by weight: 5 to 45% aloe vera; 5 to 45% cocoa butter; 5 to 45% beeswax; 5 to 45% glycerine; 5 to 45% coconut oil; 5 to 45% shea nut butter.

Another object of the present invention is to provide a lubricating and cleansing system that may be readily fabricated from materials that permit relative economy and are commensurate with durability.

Other objects features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of a razor blade lubricating and cleansing system, wherein the removable cap is attached and being used to enclose the wax core within the tubular housing.

FIG. 1B shows a perspective view of an embodiment of a razor blade lubricating and cleansing system, wherein the removable cap is unattached to expose a portion of the wax core is extended beyond the tubular housing.

FIG. 2A shows a cross-sectional view along line AA′ of and embodiment of a razor blade lubricating and cleansing system, wherein the removable cap is unattached to expose a portion of the wax core is extended beyond the tubular housing.

FIG. 2B shows a cross-sectional view along line AA′ of and embodiment of a razor blade lubricating and cleansing system, wherein the removable cap is unattached while the wax core remains withdrawn within the tubular housing.

FIG. 3A shows a perspective view of and embodiment of a razor blade lubricating and cleansing system in use at the beginning of a wiping motion across a plurality of razor blades.

FIG. 3B shows a perspective view of and embodiment of a razor blade lubricating and cleansing system in part-way through a wiping motion across a plurality of razor blades.

FIG. 3C shows a close-up view of the raised portion of a wax core of an embodiment of a razor blade lubricating and cleansing system in use extruding debris from between a plurality of razor blades.

FIG. 3D shows a close-up view of a plurality of razor blades after waste material and debris has been extruded and a lubricating layer has been applied by an embodiment of a razor blade lubricating and cleansing system.

### DETAILED DESCRIPTION OF THE INVENTION

Reference is made herein to the attached drawings. Like reference numerals are used throughout the drawings to depict like or similar elements of the razor blade lubricating and cleansing system. For the purposes of presenting a brief and clear description of the present invention, the preferred embodiment will be discussed as used for the razor blade lubricating and cleansing system. The figures are intended for representative purposes only and should not be considered to be limiting in any respect.

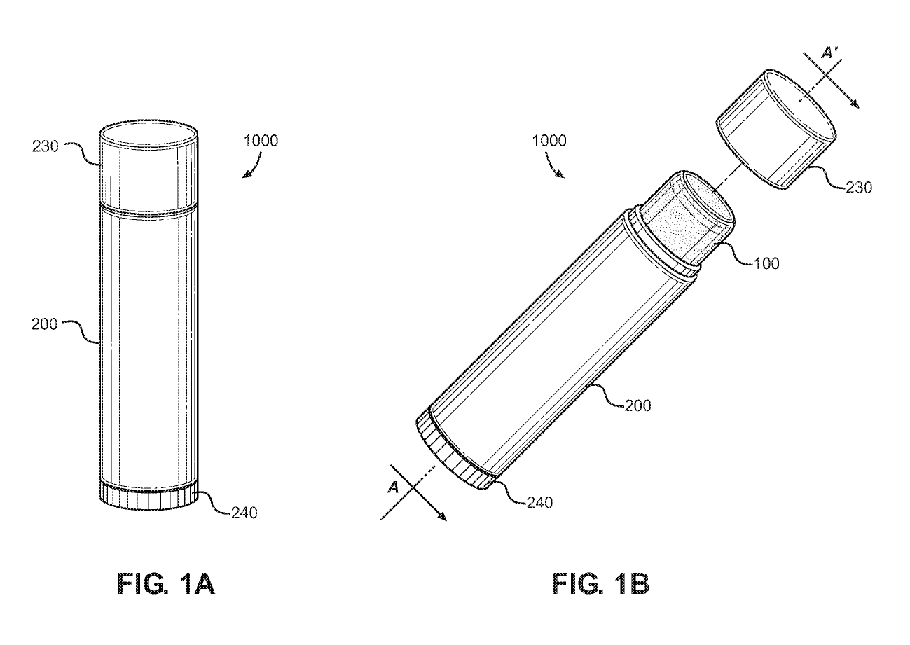

Referring now to FIGS. 1A and 1B, there are shown perspective views of an embodiment of a razor blade lubricating and cleansing system, wherein the removable cap is attached and being used to enclose the wax core within the tubular housing, and wherein the removable cap is unattached to expose a portion of the wax core is extended beyond the tubular housing, respectively. In the illustrated embodiment, a razor blade lubricating and cleansing system 1000 comprises a wax core 100 disposed within a tubular housing 200 configured to extrude debris from between a plurality of razor blades upon application, such that waste material is removed, and a coating of wax is formed along the edge and over the surface of each razor blade.

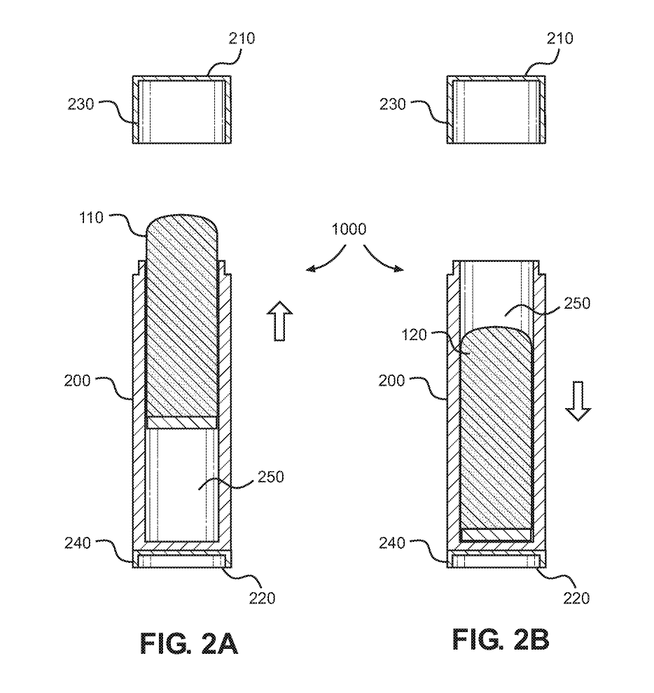

In the illustrated embodiment, the tubular housing 200 further comprises a removable cap 230 configured to removably secure to a top end (as shown in FIG. 2A, 210) of the tubular housing 200. The removable cap 230 is configured to removably secure via friction fit, however alternate fastening methods are also contemplated. In the illustrated embodiment, the removable cap 230 comprises a height sufficient to retain a portion of the wax core 100 therein, such that a user can removably secure the removable cap 230 to the tubular housing 200 while a portion of the wax core 100 is extended therefrom. In the illustrated embodiment, the tubular housing 200 further comprises a rotatable base 240 opposite the top end 210, wherein the rotatable base 240 is configured to selectively move the wax core 100 between an extended position and a retracted position when the rotatable base 240 is actuated.

Referring now to FIGS. 2A and 2B, there are shown cross-sectional views along line AA′ of and embodiment of a razor blade lubricating and cleansing system, wherein the removable cap is unattached to expose a portion of the wax core is extended beyond the tubular housing, and wherein the removable cap is unattached while the wax core remains withdrawn within the tubular housing, respectively. In the illustrated embodiment the tubular housing 200 includes an open interior volume 250 configured to house the wax core 100, the removable cap 230 disposed on the top end 210, and the rotatable base 240 disposed on a bottom end 220 configured to raise the wax core 100 upwards when rotated in a clockwise direction, such that a raised portion 110 is exposed and accessible. Additionally, the rotatable base 240 is further configured to lower the wax core 100 downwards when rotated in an anticlockwise direction, such that the lowered portion 120 is securely stowed within the open interior volume 250 of the tubular housing 200.

In one embodiment the composition of the wax core 100 of the razor blade lubricating and cleansing system 1000 comprises: aloe vera; cocoa butter; caranauba wax; glycerin; coconut oil. More specifically, another embodiment of the composition of the wax core 100 comprises by weight: 5 to 45% aloe vera; 5 to 45% cocoa butter; 5 to 45% beeswax; 5 to 45% glycerine; 5 to 45% coconut oil; 5 to 45% shea nut butter.

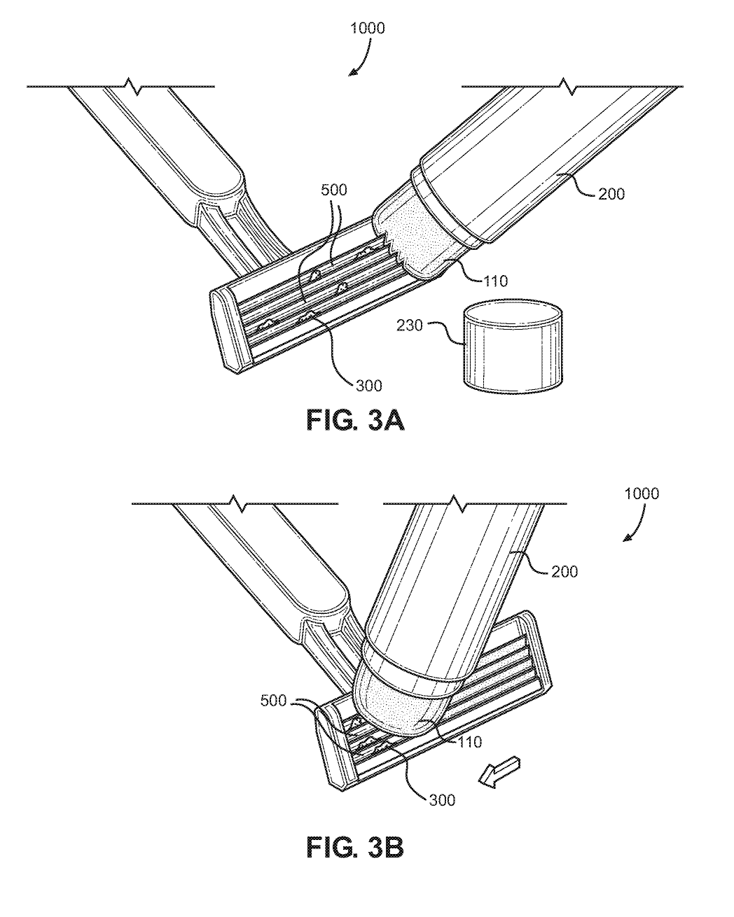

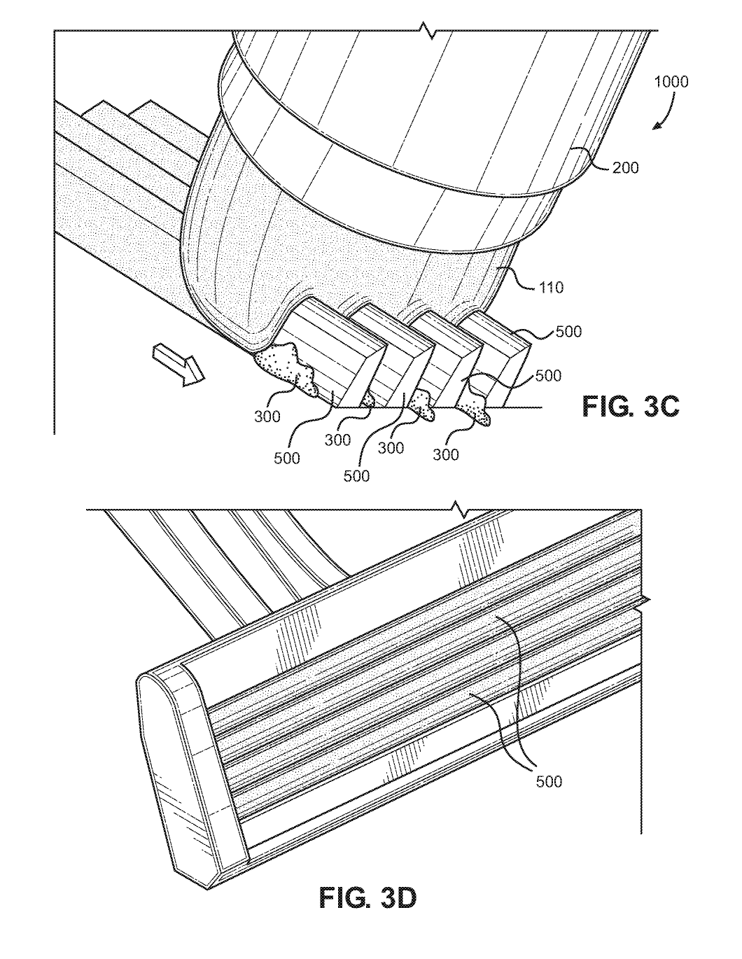

Referring now to FIGS. 3A, 3B, 3C and 3D, there are shown a perspective view of and embodiment of a razor blade lubricating and cleansing system in use at the beginning of a wiping motion across a plurality of razor blades, a perspective view of and embodiment of a razor blade lubricating and cleansing system in part-way through a wiping motion across a plurality of razor blades, a close-up view of the raised portion of a wax core of an embodiment of a razor blade lubricating and cleansing system in use extruding debris from between a plurality of razor blades, and a close-up view of a plurality of razor blades after waste material and debris has been extruded and a lubricating layer has been applied by an embodiment of a razor blade lubricating and cleansing system, respectively. A collection of debris and waste matter 300 is visibly present on a plurality of razor blades 500 in FIG. 3A. This collection of debris and waste matter 300 is shown to be removed by applying pressure onto the plurality of blades 500 with the raised portion 110 of the wax core 100 and wiping across the plurality of blades 500 as shown in FIGS. 3A, 3B, and 3C. The application of pressure allows the raised portion 110 to extend between each of the plurality of blades 500, such that the lateral movement of the wax core 100 causes the debris and waste matter 300 to be impacted thereby. More specifically, FIG. 3C shows where the raised portion 110 of the wax core is able to squeeze into the gaps between the plurality of razor blades 500 such that the debris and waste material 300 present on the surface of each blade 500 is captured and removed by the wax core 100 during the wiping motion. After the wiping motion is completed, the waste material 300 is removed and a lubricating coat of wax is left on the plurality of razor blades 500 as shown in FIG. 3D.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A razor blade lubricating and cleansing system, comprising:
a wax core disposed within a tubular housing configured to extrude debris from between a plurality of razor blades upon application, such that waste material is removed, and a coating of wax is formed along the edge and over the surface of each razor blade;
the tubular housing having a removable cap disposed on a top end, and a rotatable base disposed on a bottom end configured to raise the wax core upwards when rotated in a clockwise direction, such that the raised portion is exposed and accessible;
the rotatable base being further configured to lower the wax core downwards when rotated in an anticlockwise direction, such that the lowered portion is securely stowed within the tubular housing.

2) The razor blade lubricating and cleansing system of claim 1, wherein the composition of the wax core comprises:
aloe vera;
cocoa butter;
caranauba wax;
glycerin; and
coconut oil.

3) The razor blade lubricating and cleansing system of claim 1, wherein the composition of the wax core comprises by weight:
5 to 45% aloe vera;
5 to 45% cocoa butter;
5 to 45% beeswax;
5 to 45% glycerine;
5 to 45% coconut oil; and
5 to 45% shea nut butter.

4) A method of using a razor blade lubricating and cleansing system, comprising:
providing a wax core disposed within a tubular housing having a removable cap disposed on a top end of the tubular housing, and a rotatable base disposed on a bottom end of the tubular housing;
wherein the rotatable base is configured to selectively raise and lower the wax core within the tubular housing;
removing the removable cap from the tubular housing;
rotating the rotatable base to raise the wax core from the tubular housing such that a raised portion is exposed and accessible;
applying the raised portion of the wax core to a plurality of blades of a razor blade such that the raised portion is extruded between each of the plurality of blades;
sliding the wax core laterally along the plurality of blades from a first end thereof to a second end thereof, such that a collection of debris disposed between the plurality of blades is removed therefrom, and a lubricating coating is applied to each of the plurality of blades;
removing the raised portion from the plurality of blades.

5) The method of using a razor blade lubricating and cleaning system of claim 4, further comprising rotating the rotatable base such that the wax core is lowered until the wax core is entirely within the tubular housing.

6) The method of using a razor blade lubricating and cleaning system of claim 5, further comprising securing the removable cap to the top end.
